(19) United States
(12) Patent Application Publication
(10) Pub. No.: US 2006/0100826 A1
(43) Pub. Date: May 11, 2006

(54) Method of monitoring measurements

(76) Inventor: Paul Peterson, Booragoon (AU)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/514,688

(22) PCT Filed: May 16, 2003
(86) PCT No.: PCT/AU03/00626

§ 371 Date: Aug. 5, 2005

(30) Foreign Application Priority Data
May 16, 2002 (AU) PS 2365

(51) Int. Cl. G06F 15/00

(52) U.S. Cl. 702/189

(57) ABSTRACT

A method of monitoring a system requiring periodic measurements of a plurality of points of the system, includes the steps of identifying deterministic points in the system as those points which are determinative of one or more determined points in the system, collecting measurements from the deterministic points of the system, storing the measurements, calculating a rate of change for each of the deterministic point value using previously stored measurements, calculating a rate of change of determined points from the rate of change of the deterministic points and using the rate of change values for deterministic points and determined points to estimate when an event will occur in relation to each point.

### FIELD OF THE INVENTION

The present invention relates to a method of monitoring a system requiring periodic measurements of a plurality of points. The present application has many fields of use including systems such as a piece of equipment, an area of ground, or a manufacturing or processing plant. The areas of applicability of the present invention are not intended to be limiting.

### BACKGROUND OF THE INVENTION

Systems that require multiple periodic measurements generally result in a great deal of effort being required to log, collect and interpret the measurements. Often it is desired to predict when the measured points will reach a predetermined value. Currently the known method of doing this is to collect all of the data and compare each data value to the predetermined value.

The present invention provides a more convenient method of monitoring points of a system.

### SUMMARY OF THE PRESENT INVENTION

According to the present invention there is provided a method of monitoring a system requiring periodic measurements of a plurality of points of the system, including the steps of:

identifying deterministic points in the system as those points which are determinative of one or more determined points in the system;

collecting measurements from the deterministic points of the system;

storing the measurements;

calculating a rate of change for each of the deterministic point value using previously stored measurements;

calculating a rate of change of determined points from the rate of change of the deterministic points;

using the rate of change values for deterministic points and determined points to estimate when an event will occur in relation to each point

According to another aspect of the present invention there is provided a method of monitoring a system requiring periodic measurements of a plurality of points of the system, including the steps of.

identifying deterministic points in the system as those points which are deterministic of one or more determined points in the system;

collecting measurements from the deterministic points of the system;

storing the measurements;

calculating a rate of change for each of the deterministic point value using previously stored measurements;

calculating a rate of change of determined points from the rate of change of the deterministic points;

using the respective deterministic point or determined point rate of change value to estimate when an event will occur in relation to one or more of the points.

Preferably the methods include the step of calculating one or more ratios between the rate of change of one or more of the determined points and one or more of the deterministic points, the ratios being used in the step of calculating the rate of change of determined points.

Preferably the methods include the step of collecting measurements from one or more of the determined points, less often that the measurements are collected from the deterministic points.

Preferably the measurements from the determined points are used to calculate each ratio between the rate of change of each determined point and one or more of the deterministic points.

Preferably the measurements from the determined points are used to calculate each ratio between the rate of change of each determined point and two or more of the deterministic points.

Preferably the rate of change of a plurality of deterministic points are used to determine the rate of change of one or more determined points.

Preferably if the rate of change of one of the deterministic points is not available the remaining rates of change of the other deterministic points are used to determine the rate of change of the relevant determined points.

Preferably the rates of change are used to estimate dates when the measured values reach certain values.

According to another aspect of the present invention there is provided an apparatus for monitoring a system requiring periodic measurements of a plurality of points, said apparatus including:

means for collecting measurements from a plurality of points identified as deterministic points of the system;

means for storing the measurements;

means for calculating a rate of change of each deterministic point value using previously stored measurements;

means for calculating a rate of change of one or more determined points from the rate of change of deterministic points;

means for estimating when an event will occur in relation to one or more of the points from the respective deterministic point or determined point rate of change value.

### BRIEF DESCRIPTION OF THE DRAWINGS

In order to provide a better understanding, preferred embodiments of the present invention will now be described, by way of example only, with reference to the accompanying drawings, in which:

FIG. 1 is a schematic representation of a system requiring periodic measurements of a plurality of points; and

FIG. 2 is a flow chart showing the steps in the method of the present invention.

### DETAILED DESCRIPTION OF PREFERRED EMBODIMENTS

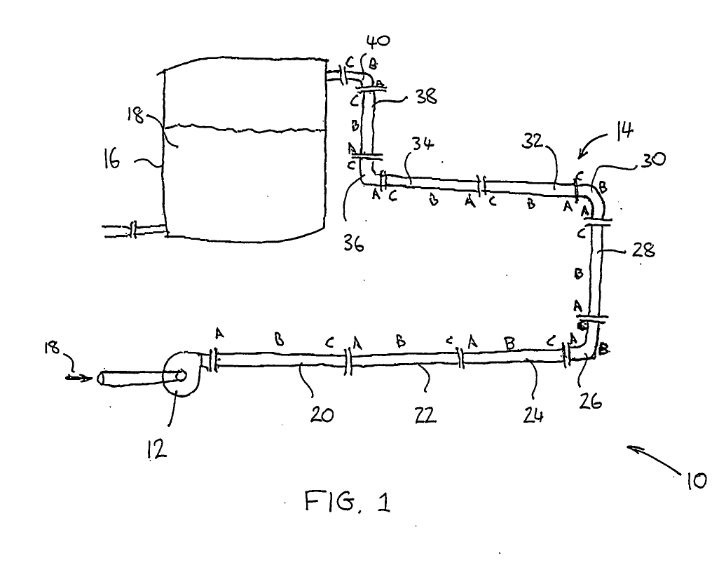

Referring to FIG. 1 there is shown a system 10 requiring the measurement of a plurality of points. The system 10 includes a pump 12, a pipe 14 and a tank 16. The pump 12 pumps fluid 18 through the pipe 14 and into the tank 16. The pipe 14 includes a series of pipe sections 20, 22, 24, 26, 28, 30, 32, 34, 36, 28 and 40. Each of the pipe sections is measured at positions A, B and C along the length of each pipe section. At each position A, B and C, four measurement points may be taken at 0°, 90°, 180° and 270° around the circumference of the pipe. The characteristic measured at each of the measuring points may be, for example, the thickness of the pipe at the measuring point This measurement may be taken, for example, to determine wall thickness if the pipe is subject to wear or corrosion or the build up of internal scale. It is clear from the simple system shown in this example that 12 measurement points are taken for each pipe section and in this example there are 11 pipe sections with the result being 132 measured points if every point is measured. By identifying points deterministic of the characteristic being measured at other points less points can be measured. In this example, measurement position B in pipe section 26, is likely to be deterministic of other points in the system. As a result, the four measurements at 26B can be measured at the usual frequency of measurement with all of the other points of pipe section 26 being measured less frequently.

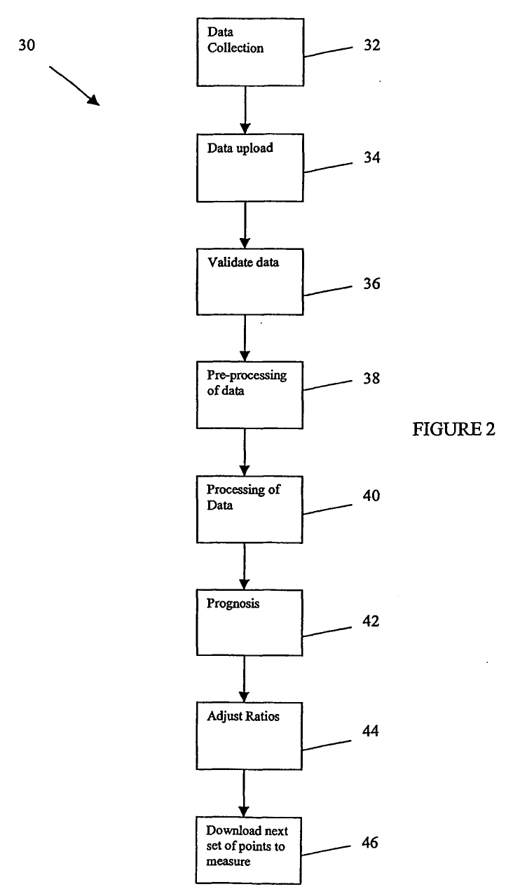

Referring to FIG. 2 the method 30 of the present invention is shown. The first step is a collection of data 32. Data is collected by, for example a data logger, process control equipment or another form of measuring device. Generally a large number of points will have data measured, rather than the 132 in the simple example of FIG. 1. Due to the large number of data points it is important that data be structured in a way that simplifies location of a sub-set for analysis. To achieve this, points are located on plant records. Plant records are arranged in a recursive hierarchy so that as many parent/child levels can be constructed as desired. Plant records are contained within departments so that selecting a department reduces the plant records data set to those that are relevant. Departments are located within sites. Sites are located within companies.

Once the data is collected it is uploaded at 34 to a database. Data is often extracted from collection devices in a variety of formats. Data must therefore be formatted so that it can be interpreted. Parsing of the data preferably extracts the following information:

plant or system code;

point label;

value;

unit of measure;

date of measurements;

flags and miscellaneous attributes.

The extracted data is uploaded to a staging table which is then processed by a plant ID number and point ID number for each measurement.

Data from the staging table is then validated at 36. The data in the staging table is reviewed to detect unacceptable anomalies. Validation includes the following checks:

imported data are matched with a plant code and point label in the database of plant names and points;

non-matched data may be stored in a temporary area for later manual processing or allocated a dummy plant code and point label for later insertion in the plant hierarchy,

certain points are expected to trend upwards over time, taking into account a specified tolerance;

certain points are expected to trend downwards over time, taking into account a specified tolerance;

the department in which the point resides has not been marked to warn when important values are zero or to a user defined reject value (eg. in some loggers nonsense data is given the value 99999);

records must have a value that is numeric;

records must have a unit of measure.

Records that fail to meet the first five requirements are returned to the user for action. Records that fail to meet the last two requirements are excluded from processing. The user can fix the data value, mark it for fixing later, indicate that the plant has been altered or omit that record from import into the database, or cease the import, repair the dataset and then import it again.

Data that is imported for fixing later or where the plant has been altered will use an historical rate of change and not the one based on the new measured value.

Pre-processing of the validated data occurs at 38. The data from the staging table are stored in a readings table with calculations being performed on the data in the readings table.

The change in the measured variable between the actual measurement intervals is determined. This is termed Dv. That is, the current data value has the previous data value subtracted to determine the change. Dv values that trend in the wrong way within a tolerance will be treated as equal to zero. If the point is supposed to trend down and the new Dv value is greater than a specified tolerance then Dv for the reading is set to null. Similarly, readings that are expected to trend upwards but reduce in magnitude within the tolerance are set to 0, outside the tolerance are set to null. If a system item is marked as altered during the period since the last data input, the Dv calculation is omitted as the value may not be valid due to the change to the system 10. An alteration may be due to the replacement of a worn part or a change in the structure of the system.

The change in time between the previous actual readings, termed Dt, is calculated. This is simply the difference in date/time values between the most recent and the previous readings. Time is typically measured in days although other time units maybe used depending on the application.

The weighted rate of change of the point (Dt/DvWtd) is calculated. The most recent rate of change (Dv/Dt) is determined by dividing the change in the Dv by Dt. The latest Dv/Dt value along with previous Dv/Dt values are used in a weighting profile to smooth out variations in the measured variable. The result is stored on the point record. The weighting profile uses an array of, for example, up to the ten most recent Dv/Dt values. The profile to be used for each point is stored in a point record. Each profile in the library of profiles must have a series of up to ten percentages that must add to unity. The simplest of these would be 100% for the latest Dv/Dt value, other examples include 60/40 being 60% of the latest 40% of the second most recent values; 70/20/10 or a linear model. A table of example weighting profiles follows:

| Most recent | | | | | | | | | 10 Measurements ago | | |
|---|---|---|---|---|---|---|---|---|---|---|---|
| Dv/Dt | 0.0112 | 0.012 | 1E−04 | 0.014 | 0.012 | 0.043 | 0.012 | 0.017 | 0.0.163 | 0.017 | Dv/DtWtd |
| Latest | 100 | 0 | 0 | 0 | 0 | 0 | 0 | 0 | 0 | 0 | 0.0112 |
| 60/40 | 60 | 40 | 0 | 0 | 0 | 0 | 0 | 0 | 0 | 0 | 0.0159 |
| 70, 20, 10 | 70 | 20 | 10 | 0 | 0 | 0 | 0 | 0 | 0 | 0 | 0.0125 |
| Linear | 10 | 10 | 10 | 10 | 10 | 10 | 10 | 10 | 10 | 10 | 0.0167 |

Any set of historical readings having null Dv values within the (range of) profile values (about zero) does not have a new Dv/DtWtd value calculated. In this case, the previously calculated value is kept for calculations. Points in the plant that have been altered during the period spanning the weighting profile do not have the Dv/DtWtd calculated due to the change of system 10.

Each reading is provided with an instance counter for storing respective instances of the data value. Readings on or prior to a plant record being (date) altered have the respective instance counter set to null. Each point has a reference to a weighting profile. Each profile has a record for the instance and the weighting percentage to be applied. The resulting value of the weighted rate of change (Dv/DtWtd) for the point is stored on the point record. Alternatively, the weighted values are calculated on the fly from stored measurement records.

The weighted rate of change of this pre-processed data is then processed at 40. Points in the same group of a plant are identified as either deterministic (also referred to as signature points) or determined points (also referred to as derived points). All of the signature points in groups of data to be analysed should be included in the measured points. In the example shown in FIG. 1, one of the measured points at location B of pipe section 26 may be a signature point. In a more preferred form of the invention any or all of the points at location B of pipe section 26 may be signature points.

Each signature point is used to derive the other points in the group that are not included in the imported data. Again in the more preferred form of the invention, a plurality of signature points are aggregated (such as by taking the average, the minimum or the maximum) to derive other points in the group. As a result it is not necessary to measure each of the derived points in the group although some of the derived points may be measured in addition to the signature points in the group. A signature ratio is calculated for each derived point in the group. The signature ratio is historically derived from previous group point's rate of change divided by the signature point rate of change. Thus, for non-measured, derived points in the group the weighted rate of change is calculated from the signature points weighted rate of change multiplied by the points signature ratio. Points that are calculate are marked as calculated, whereas points that are measured are marked as actual so that it is possible to distinguish between the derivation of the rate of weight of change of each point. Values are stored in a historical reading table.

In the more preferred version calculated rates of change and determined points are always calculated on the fly.

The processed data is then used to calculate and/or update prognosis of the likely time that measurement will reach an alarm value or a critical value. A warning value may also be used. Particular points or every point affected by the uptake of readings can be calculated as follows:
Warning Date=[Date of Latest Reading]+(([Warning Value]−[Latest Value])/[Dv/DtWtd])
Alarm Date=[Date of Latest Reading]+(([Alarm Value]−[Latest Value])/[Dv/DtWtd])
Critical Date=[Date of Latest Reading]+(([Critical Value]−[Latest Value])/[Dv/DtWtd])

To ensure that the signature point ratios are accurate an adjustment of the ratios occurs at 44. This occurs where points that are actually measured are given the opportunity to adjust the ratio between the rate of change of the measured point and that of the signature point. In the more preferred system the rations are always calculated in real time as needed. The signature ratio is calculated by dividing the latest rate of change for the point by the rate of change of the signature point over the same period. Since signature points should be measured more often than group points the calculation therefore involves averaging the Dv/Dt values for the signature point over the period spanning the two most recent group point readings. Since the group points have their own group point readings it is necessary to calculate the signature rate of change separately for each group point. The signature ratio for signature points is always unity so that they can be excluded from signature ratio calculations.

Since the frequency of measuring derived points should be less than the frequency of measuring signature point and the calculation of alarm and critical dates can be estimated, scheduling for measurement of points can be achieved to provide optimum route selection and/or cost savings, as indicated in 46.

In the more preferred form where multiple signature points are used to determine the derived points, where one of the signature points is altered, the remainder of the signature points can be used to derive the ratio for the derived point. This overcomes the problem of where a single signature point is used and is modified (such as when a component is replaced), a delay occurs until enough data is provided to determine the weighted ratio for that signature point.

Points are typically measured in predefined sequences that facilitate access in the field. Sequences are called routes and are often in an order that is not simply determined by plant coding. The reason is that the routes are often defined by physical access restraints in the field. Any point can reside in the many routes and can be in a different sequence in each route. Routes are used to export the data to data loggers in the order that they will most easily be encountered in the field. This allows the user taking readings to simply enter the measurement with one press of a button on the device and the next point is displayed ready for measurement. This greatly speeds up the measurement process.

Plant items can be selected for export to a data logger by use of a drilldown hierarchy display. Highlighting a record within a hierarchy and selecting the plant item will include all children ancestors of that item. Many sections of the plant can be selected one after another. Selected routes and points on the selected plant can be passed onto a select point for export grid.

A matrix with calculated points, signature points and/or points across the top and points due in alarm and points in critical alarm allow a wide selection of points from the plants and routes selected for downloading. The user can select respective points to download to determine a route. The export process can filter out desired points and send them to an export program for downloading to the data logger.

The points for the next reading can then be exported by various means depending on the data logger type. After the points are reviewed, the user can select the type of data logger format for export and then the data can be downloaded to the data logger.

This process can therefore eliminate points that either do not need to be measured or can be measured less frequently thus saving time. In addition, a plant containing many measurement points, only those points that require measurement such as signature points or derived points that have not been measured in some time need be included in the route. This will also allow a staggered measuring of derived points, which can be designed to suit for example down time in a plant where it is otherwise not possible, or at least difficult, to gain access to take a measurement.

The skilled addressee will realise that modifications and variations may be made to the present invention without departing from the basic inventive concept. Such modifications include the number and nature of measurements taken, the weighting of the rate of change, the data value, the period or frequency of measurement and the application of the present invention beyond manufacturing and processing plants.

Such modifications and variations are intended to be within the scope of the present invention, the nature of which is to be determined from the foregoing description.

1. A method of monitoring a system requiring periodic measurements of a plurality of points of the system, including the steps of:
identifying deterministic points in the system as those points which are determinative of one or more determined points in the system;
collecting measurements from the deterministic points of the system;
storing the measurements;
calculating a rate of change for each of the deterministic point value using previously stored measurements;
calculating a rate of change of determined points from the rate of change of the deterministic points;
using the rate of change values for deterministic points and determined points to estimate when an event will occur in relation to each point.

2. A method of monitoring a system requiring periodic measurements of a plurality of points of the system, including the steps of:
identifying deterministic points in the system as those points which are deterministic of one or more determined points in the system;
collecting measurements from the deterministic points of the system;
storing the measurements;
calculating a rate of change for each of the deterministic point value using previously stored measurements;
calculating a rate of change of determined points from the rate of change of the deterministic points;
using the respective deterministic point or determined point rate of change value to estimate when an event will occur in relation to one or more of the points.

3. A method according to either claim 1 or 2, wherein the method further includes the step of calculating one or more ratios between the rate of change of one or more of the determined points and one or more of the deterministic points, the ratios being used in the step of calculating the rate of change of determined points.

4. A method according to either claim 1 or 2, wherein the method includes the step of collecting measurements from one or more of the determined points, less often that the measurements are collected from the deterministic points.

5. A method according to either claim 1 or 2, wherein the measurements from the determined points are used to calculate each ratio between the rate of change of each determined point and one or more of the deterministic points.

6. A method according to either claim 1 or 2, wherein the measurements from the determined points are used to calculate each ratio between the rate of change of each determined point and two or more of the deterministic points.

7. A method according to either claim 1 or 2, wherein the rate of change of a plurality of deterministic points are used to determine the rate of change of one or more determined points.

8. A method according to either claim 1 or 2, wherein if the rate of change of one of the deterministic points is not available the remaining rates of change of the other deterministic points are used to determine the rate of change of the relevant determined points.

9. A method according to either claim 1 or 2, wherein the rates of change are used to estimate dates when the measured values reach certain values.

10. An apparatus for monitoring a system requiring periodic measurements of a plurality of points, said apparatus including:
means for collecting measurements from a plurality of points identified as deterministic points of the system;
means for storing the measurements;
means for calculating a rate of change of each deterministic point value using previously stored measurements;
means for calculating a rate of change of one or more determined points from the rate of change of deterministic points;
means for estimating when an event will occur in relation to one or more of the points from the respective deterministic point or determined point rate of change value.
